(19) United States
(12) Patent Application Publication
(10) Pub. No.: US 2024/0331965 A1
(43) Pub. Date: Oct. 3, 2024

(54) REFERENCE ELECTRODE FOR HIGH TEMPERATURE CORROSION SENSOR APPLICATIONS

(71) Applicant: West Virginia University Board of Governors on Behalf of West Virginia University, Morgantown, WV (US)

(72) Inventors: Shanshan Hu, Morgantown, WV (US); Xingbo Liu, Morgantown, WV (US)

(21) Appl. No.: 18/623,300

(22) Filed: Apr. 1, 2024

Related U.S. Application Data
(60) Provisional application No. 63/493,459, filed on Mar. 31, 2023.

(51) Int. Cl. H01J 1/148; G01K 7/16

(52) U.S. Cl. CPC H01J 1/148; G01K 7/16

(57) ABSTRACT

Various examples are provided related to electrodes for high temperature electrochemical corrosion sensing. In one example, a high temperature sensor electrode includes a quartz tube; a copper chloride and sodium chloride mixture sealed in the quartz tube; and an electrode wire in the mixture, the electrode wire including an electrode connection extending through a seal of the quartz tube. In another example, a method for electrochemical testing includes immersing electrodes of a high temperature electrochemical sensor in a corrosive medium, the electrodes comprising a high temperature sensor electrode; and obtaining one or more electrochemical measurement via the electrodes immersed in the corrosive medium. The electrodes can also include a working electrode and/or a counter electrode.

### CROSS REFERENCE TO RELATED APPLICATIONS

This application claims priority to, and the benefit of, U.S. provisional application entitled “Improved Reference Electrode for High Temperature Corrosion Sensor Applications” having Ser. No. 63/493,459, filed Mar. 31, 2023, which is hereby incorporated by reference in its entirety.

### STATEMENT REGARDING FEDERALLY SPONSORED RESEARCH OR DEVELOPMENT

This invention was made with government support under Grant No. DE-FE0031548 awarded by the Department of Energy. The Government has certain rights in the invention.

### BACKGROUND

Hot corrosion refers to the accelerated degradation of alloys beneath a thin layer of molten salt at elevated temperatures, analogous to atmospheric corrosion. It has been extensively observed in coal fired power plants and other high temperature industries and can result in large economic losses associated with the maintenance or replacement of various hot components, or even the forced outages. The main chemical involved in the molten salt is Na₂SO₄ due to its extraordinary stability over a wide range of oxygen partial pressure and temperature. To maximize the effectiveness and efficiency of the periodic maintenance, it is important to monitor the degradation of hot components. Wherein, the most effective and efficient method is electrochemical measurements such as open circuit potential (OCP), potentiodynamic polarization (PDP) and electrochemical noise (EN). To accurately monitor or regulate the potential, it is necessary to incorporate a reliable reference electrode with good stability, reproducibility, non-polarizability, reversibility and durability.

### SUMMARY

Aspects of the present disclosure are related to electrodes for high temperature corrosion sensors. In one aspect, among others, a high temperature reference electrode comprises a quartz tube; a copper chloride and sodium chloride mixture sealed in the quartz tube; and an electrode wire disposed in the copper chloride and sodium chloride mixture, the electrode wire comprising an electrode connection extending through a seal of the quartz tube. In one or more aspects, the electrode wire can be a copper wire disposed in the copper chloride and sodium chloride mixture. A diameter of the copper wire can be in a range from about 0.5 mm to about 2.5 mm. The diameter of the copper wire can be 1 mm. The electrode connection can comprise a tungsten wire welded to an end of the copper wire, the tungsten wire extending through the seal of the quartz tube. A diameter of the tungsten wire can be in a range from about 0.2 mm to about 1 mm. The diameter of the tungsten wire can be 0.4 mm. The high temperature reference electrode can have an ohmic resistance of about 6.7 kΩ at 500° C.

In various aspects, the copper chloride and sodium chloride mixture can have a molar ratio of 1:9. A diameter of the quartz tube can be about 10 mm or less. A thickness of the quartz tube can be about 1 mm or less. The thickness of the quartz tube can be about 0.4 mm. The high temperature reference electrode can be a reference electrode in a high temperature electrochemical corrosion sensor.

In another aspect, a method for electrochemical testing comprises immersing electrodes of a high temperature electrochemical sensor in a corrosive medium, the high temperature electrochemical sensor comprising a high temperature reference electrode comprising: a quartz tube; a copper chloride and sodium chloride mixture sealed in the quartz tube; and an electrode wire disposed in the copper chloride and sodium chloride mixture, the electrode wire comprising an electrode connection extending through a seal of the quartz tube; and obtaining one or more electrochemical measurement via the electrodes immersed in the corrosive medium. In one or more aspects, the high temperature electrochemical sensor can comprise a working electrode comprising an alloy under test. The alloy can be an austenitic stainless steel. The austenitic stainless steel can be TP347H stainless steel. The electrodes can comprise a plurality of working electrodes. In various aspects, the corrosive medium can comprise coal ash or other molten salts. The one or more electrochemical measurement can comprise open circuit potential (OCP), potentiodynamic polarization (PDP) or electrochemical noise (EN).

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate an example of a quartz sealed Cu/Cu²⁺ electrode which can be used in a high temperature electrochemical sensor, in accordance with various embodiments of the present disclosure.

FIG. 2 illustrates an example of a linear relationship between log (T/R) and 100/T of the quartz sealed Cu/Cu²⁺ electrode of FIG. 1A, in accordance with various embodiments of the present disclosure.

FIGS. 3A and 3B illustrate examples of potential difference between two similar quartz sealed Cu/Cu²⁺ electrodes in synthetic coal ash as a function of time at (a) 500° C. and (b) 800° C., in accordance with various embodiments of the present disclosure.

FIGS. 4A-4E illustrate examples of chronopotentiometry of two similar Cu/Cu²⁺ electrodes at different temperatures (a) 500° C., (b) 600° C., (c) 700° C., (d) 800° C. and (e) 900° C. after the flow of a small current for 300 s, in accordance with various embodiments of the present disclosure.

FIG. 5 illustrates examples of a micropolarization test of the Cu/Cu²⁺ electrode at 500° C., 600° C., 700° C., 800° C. and 900° C., in accordance with various embodiments of the present disclosure.

FIG. 6 illustrates an example of an OCP measurement as a function of time in the first hour at 700° C., in accordance with various embodiments of the present disclosure.

FIGS. 7A-7D illustrate examples of potential and current noise before (7A and 7B) and after (7C and 7D) detrending of TP347H stainless steel as a function of time at 650° C. for 3d with 2 mm coal ash, in accordance with various embodiments of the present disclosure.

FIG. 8 includes images illustrating cross-section morphology and corresponding element distribution mapping of TP347H stainless steel after coal ash hot corrosion at 700° C. for 72 h, in accordance with various embodiments of the present disclosure.

FIGS. 9A and 9B illustrate examples of noise resistance in the time domain and frequency domain, and PDP after hot corrosion at 700° C. for 72 h, in accordance with various embodiments of the present disclosure.

### DETAILED DESCRIPTION

Disclosed herein are various examples related to electrodes for high temperature corrosion sensing such as, e.g., Cu/Cu²⁺ reference electrodes. Reference will now be made in detail to the description of the embodiments as illustrated in the drawings, wherein like reference numbers indicate like parts throughout the several views.

There are several kinds of reference electrodes for molten salts reported in the previous related works. Inert materials (i.e., Pt and graphite) are often adopted as the pseudo-reference or quasi-reference electrode due to their simplicity and small ohmic resistance. However, the shortcomings of the lack of a thermodynamic equilibrium, a shift of potential during measurement and limited working conditions strictly restrain their utilization. By adopting a stable redox potential of the Ag—Ag⁺ couple, various types of Ag—AgCl reference electrodes, e.g., quartz tube, porcelain, silica or alumina enclosing Ag—AgCl have been developed for high temperature molten salts. Unfortunately, multiple disadvantages of this redox couple include the easy decomposition of AgCl under exposure to light, the formation of Ag⁺-complexes with the co-existing anions and temperature gradient-induced precipitation or dissolution of Ag on silver wire, all of which significantly impair the reliability of the Ag—AgCl-type reference electrode. The decomposition of AgCl might be mitigated by replacing it with Ag₂SO₄. However, the melting point of Ag₂SO₄, 652° C., is much higher than that of AgCl, i.e., 455° C., which reduces the service temperature range. Therefore, a new reference electrode is needed to accurately regulate or monitor the potential which can be employed in a wide temperature range comparable to that of the Ag—AgCl reference electrode.

A novel quartz tube sealed Cu/Cu²⁺ reference electrode is provided which possesses good reproducibility, stability, non-polarizability, reversibility and durability in the temperature range between 500° C. (Centigrade) and 900° C. in synthetic coal ash composed of molten sulfate salts and some oxides. With the assistance of this robust reference electrode, electrochemistry measurements including OCP, EN and PDP have been successfully conducted to tentatively probe the corrosion behavior of TP347H, a representative of austenitic stainless steel which has been extensively used to make hot components in coal fired power plants due to its attractive resistance against hot corrosion and good mechanical properties, in synthetic coal ash.

### Preparation of Cu/Cu²⁺ Reference Electrode

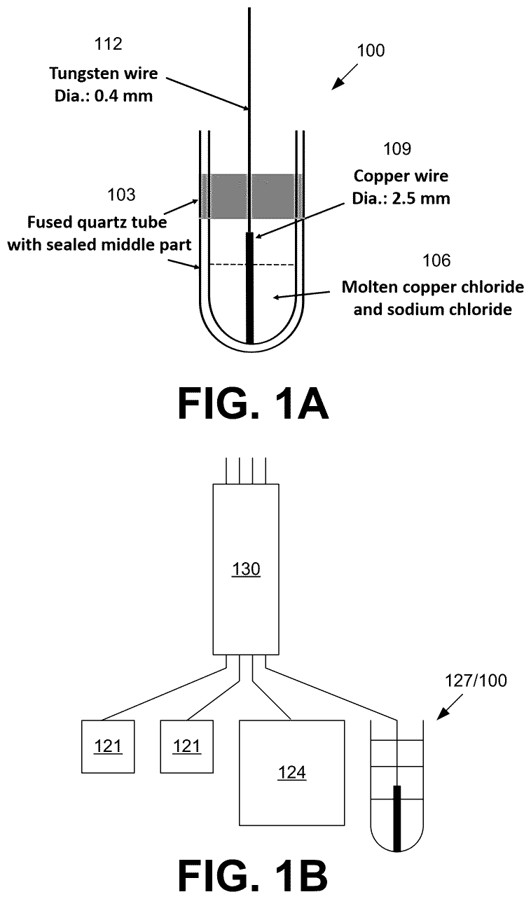

A quartz tube sealed Cu/Cu²⁺ electrode was fabricated and tested as a reference electrode. FIG. 1A illustrates an example of the electrode 100 including a quartz tube 103 containing a copper chloride and sodium chloride mixture 106 sealed in the quartz tube 103. The quartz tube 103 can be fused to seal the middle part as shown in FIG. 1A. A copper electrode wire 109 is disposed in the copper chloride and sodium chloride mixture 106 and extends toward the seal of the quartz tube 103. The copper electrode wire 109 includes an electrode connection 112 extending through the seal of the quartz tube 103. In FIG. 1A, the electrode connection 112 is a tungsten wire extending from the end of the copper wire 109 as shown.

A quartz sealed Cu/Cu²⁺ electrode 100 was prepared by adding CuCl₂ (e.g., 99.9%, Sigma-Aldrich, melting point, 498° C.) and NaCl (e.g., 99.9%, Sigma-Aldrich, melting point, 801 C) with a molar ratio of 1:9 into a quartz tube 103 with one closed end (e.g., Advalue Technology Inc.) by following the preparation process of the Ag/AgCl reference electrode disclosed in “A quartz sealed Ag/AgCl reference electrode for CaCl2 based molten salts” by Pei Gao et al. (Journal of Electroanalytical Chemistry, 579 (2): 321-328, June 2005). The starting melting point of this mixture of CuCl₂ and NaCl measured by DTA is around 386.1° C., lower than the lowest experimental temperature, i.e., 500° C. A copper wire 109 with a diameter of 1 mm (e.g., 99.99%, Surepure Chemetals Inc, melting point, 1085° C.) was immersed into the salt. Copper wires of other diameters (e.g., in a range from about 0.5 mm to about 2.5 mm, or about 0.7 mm to about 2 mm, or about 0.8 mm to about 1.5 mm, where about is ±10%) can be used. The exposed Cu wire 109 was spot-welded to a tungsten wire 112 with a diameter of 0.4 mm (e.g., 99.99%, Surepure Chemetals Inc). Electrode connection wires 112 of other diameters (e.g., in a range from about 0.2 mm to about 1 mm, or about 0.25 mm to about 0.75 mm, or about 0.3 mm to about 0.5 mm, where about is ±10%) can be used. The outer diameter and thickness of this quartz tube 103 was 8 mm and 1 mm, respectively. Dimensions of the quartz tube 103 can be varied depending on the application. For example, the diameter can be in a range from about 5 mm to about 20 mm, about 6 mm to about 15 mm, or about 7 mm to about 10 mm, or can be less, where about is ±10%. The wall thickness can be in a range from about 1 mm to about 2 mm or can be less than 1 mm, where about is ±10%. The residual air in the quartz tube was exhausted with the assistance of a vacuum pump while the open end was sealed with the aid of an oxygen-methane flame. The schematic of the reference electrode is depicted in FIG. 1A.

To minimize the electric resistance of this reference electrode, the quartz tube was thinned manually by grinding using SiC abrasive paper. The final thickness of the quartz tube was about 0.4 mm, where about is ±10%. The potential difference between the quartz sealed Cu/Cu²⁺ reference electrode and a quartz tube sealed Ag/Ag₂SO₄ (molar ratio between Ag₂SO₄ and NaCl is 1:9) has been experimentally verified to be around 0.45 V at 600° C., 650° C. and 700° C., demonstrating the half reaction in Cu/CuCl₂ reference electrode is Cu+2e↔Cu²⁺ (the standard potential of Ag/Ag⁺, Cu/Cu²⁺, Cu/Cu⁺ is 0.8 V, 0.36 V and 0.18 V, respectively).

### Performance of Cu/Cu²⁺ Reference Electrode

The electrochemical measurements were conducted in an alumina crucible which was filled with synthetic coal ash with a composition of 40% SiO₂ (99.9%, Sigma-Aldrich), 40% Al₂O₃ (99.9%, Sigma-Aldrich), 9% Fe₂O₃ (99.9%, Sigma-Aldrich), 5% Na₂SO₄ (99.9%, Sigma-Aldrich), 5% K₂SO₄ (99.9%, Sigma-Aldrich) and 1% NaCl (99.9%, Sigma-Aldrich). Except where otherwise specified, the synthetic coal ash was used as the electrolyte in the following tests. Electrodes 100 were connected to a Gamry 1010E interface. Synthesized flu gas with a composition of 1 vol. % SO₂, 4 vol. % O₂, 15 vol. % CO₂ and 80 vol. % N₂ was fed at a flow rate of 100 ml min⁻¹ to simulate the working condition in a coal-fired power plant. The coal ash started to melt from 535° C. to form a molten salt layer with the feed of flu gas. All the electrodes 100 were spot welded to a tungsten wire 112 with a diameter of 0.4 mm which was shielded in a ceramic tube to avoid oxidation. The experimental temperature varied from 500° C. to 900° C.

With the quartz sealed Cu/Cu²⁺ reference electrode 100 as the counter electrode, a piece of platinum with the dimension of 20×20 mm² or another quartz sealed Cu/Cu²⁺ reference electrode 100 was used as the working electrode which was placed with a spacing of 1 cm. A small voltage, i.e., 20 mV, was applied to measure the response of current between the two electrodes for a few milliseconds. By assuming that the equivalent circuit of this system is a resistor and a capacitor connected in series, the value of this resistance can be calculated by the voltage and instantaneous current using the Ohm's law. The resistance of this reference electrode 100 is the difference between two values obtained with the platinum and the reference electrode 100 used as the working electrode, respectively. Each reported value is the average of five measurements. In this experiment, the coal ash was replaced by molten salt composed of Na₂SO₄ and K₂SO₄ with a weight ratio of 1:1 to minimize the resistance of electrolyte.

The reproducibility of this reference electrode 100 was checked by measuring the potential difference between two similar reference electrodes 100 made at separate times. Every reference electrode 100 was immersed into the synthetic coal ash with the same depth, i.e., 1 cm, to ensure the same contact area.

The stability of the reference electrode 100 was probed by measuring the potential difference between two similar reference electrodes 100 as a function of time.

A micropolarization test was conducted to check the reversibility of this reference electrode 100 by adopting the reference electrode 100 as the working electrode and a piece of platinum as the counter electrode with a scan rate of 0.5 mV s⁻¹ in a potential range between −5 mV and 5 mV versus OCP. The potential was designed to sweep from 0 mV to 5 mv, then from 5 mV to −5 mV, finally back to 0 mV vs. OCP.

Galvanostatic chronopotentiometry was adopted to reveal the cathodic and anodic polarization of this reference electrode 100. The open circuit potential between two similar reference electrodes 100 was measured after a small current (1, 2 and 3 mA) passed through it with a duration of 300 s.

### Application of Cu/Cu²⁺ Reference Electrode in Electrochemical Tests

All electrochemical tests including OCP, EN and PDP were conducted at 700° C. using the developed high temperature electrochemical sensor, which included two identical working electrodes 121 (i.e., a piece of TP347H stainless steel with a dimension of 10×10×3 mm³), one counter electrode 124 (i.e., a piece of platinum with a dimension of 20×20×0.5 mm³), and one reference electrode 127 (i.e., the quartz sealed Cu/Cu²⁺ reference electrode 100), as shown in FIG. 1B. Both working electrodes 121 were sealed with the aid of ceramic paste leaving a working surface of 10×10 mm² which was covered by 1 mm of coal ash. All these electrodes were welded with tungsten wires which were placed into an alumina tube 130 to avoid oxidation at elevated temperatures.

The OCP of one TP347H working electrode 121 with respect to the Cu/Cu²⁺ reference electrode 127/100 was measured in the first hour using the platinum counter electrode 124. Then the EN test was executed over a prolonged time period of 72 h with a frequency of 1 Hz by measuring the current noise of the two TP347H working electrodes 121 in zero-resistance ammeter (ZRA) mode and the potential noise of one TP347H working electrode 121 with respect to the Cu/Cu²⁺ reference electrode 127/100. The PDP test was performed at the end of the EN test with a scan rate of 0.5 mV s⁻¹ from −2 V to 2 V versus OCP.

### Weight Loss Measurement and Characterization

The weight and surface area of four TP347H samples with a dimension of 10×10×5 mm³ were recorded. Then all four samples were buried in the coal ash in an alumina crucible which was placed in the tube furnace with the feed of the same flu gas. After 72 h, the corrosion products on three samples were removed in boiling water for 20 minutes followed by ultrasonic cleaning in acetone, then rinsing with distilled water and drying in cold air. The final weights of the three samples were measured with the aid of a microbalance with an accuracy of 1×10⁻⁶ g. The cross-section morphology of the corrosion product and corresponding elemental distribution mapping were characterized by SEM equipped with EDX.

### Electric Resistance of Ionic Conduction of Sodium Through Quartz Tube

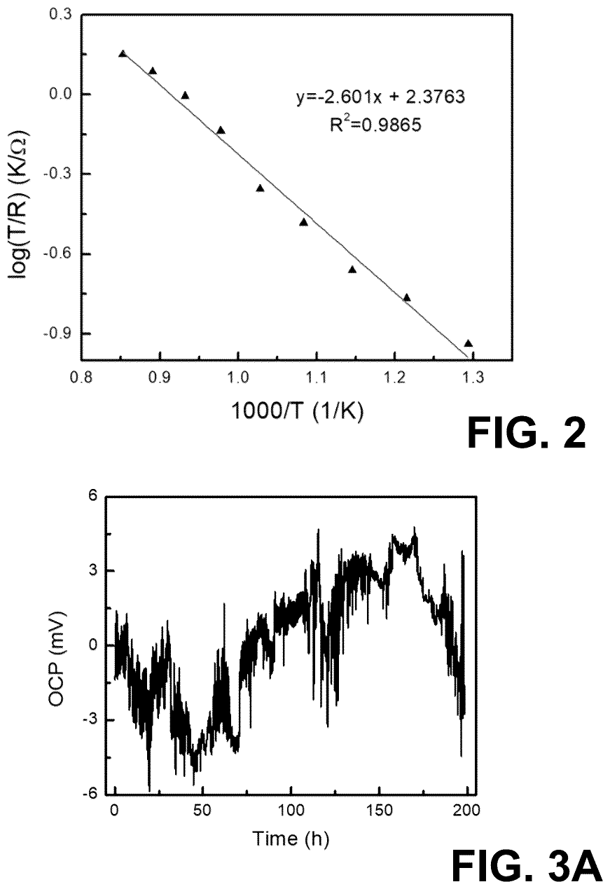

The ohmic resistance of the Cu/Cu²⁺ reference electrode in molten sodium sulfate is summarized in TABLE 1. The uncertainties of the resistance values were expected not to exceed +/−50% due to the different configuration between Cu/Cu²⁺ reference electrode and platinum and the delayed response of current. The data clearly reveal that the ohmic resistance decreases with increasing temperature. FIG. 2 reveals the good linear correlation between log₁₀ (T/R) (denoted as log (T/R)) and 1000/T, with an R² of 0.9865.

TABLE 1
The electric resistance of Cu/Cu²⁺ reference electrode
in molten sulfate salt at different temperatures

| | Temperature (° C.) | | | | | | | | |
|---|---|---|---|---|---|---|---|---|---|
| | 500 | 550 | 600 | 650 | 700 | 750 | 800 | 850 | 900 |
| Resistance (Ω) | 6.7k | 4.8k | 4.0k | 2.8k | 2.2k | 1.4k | 1086 | 920 | 830 |

The ohmic resistance of this reference electrode may be attributed to the diffusion of sodium ions through the quartz tube 103 (FIG. 1A). FIG. 2 illustrates the linear relationship between log (T/R) and 100/T of the reference electrode from the data in TABLE 1. The straight line in FIG. 2 suggests that the conduction of sodium ions through quartz tube is a thermally activated process, defined by:

$$\frac{T}{R} = α \cdot exp ( \frac{{E}_{1}}{k T} ) , \qquad ( 1 )$$

wherein, α is the pre-exponential factor; T is the experimental temperature, in K; R is the ohmic resistance of the reference electrode, in Ω; E₁ is the activation energy, in J, and k is the Boltzmann constant (1.381×10⁻²³ J/K). The slope of the fitting line in FIG. 2 is −2.061, yielding an activation energy of 0.52 eV (1 eV=1.602×10⁻¹⁹ J). This value is much smaller than the one reported in “A quartz sealed Ag/AgCl reference electrode for CaCl2 based molten salts” by by Gao et al., i.e., 1.36 eV, due to the thinner wall of the quartz tube 103.

As shown in TABLE.1, it clearly reveals that the ohmic resistance of the reference electrode 100 even at 500° C. (i.e., 6.7 kΩ is far lower than 10¹²Ω, i.e., the resistance of the input impedance of the Gamry 1010E, demonstrating its applicability in a wide temperature range from 500° C. to 900° C.

### Reproducibility, Stability, Durability and Reusability

The cell diagram of two similar quartz sealed Cu/Cu²⁺ reference electrodes immersed in the coal ash is denoted as:
Cu(s)|CuCl₂(I)+NaCl (I)∥quartz tube∥Na₂SO₄(I)+K₂SO₄(I)∥quartz tube∥CuCl₂(I)+NaCl (I)|Cu(s)
   SiO₂ is stable in basic molten sulfate salt and the dissolution of SiO₂ in acidic fused sulfate salt is a chemical dissolution process without any charge transfer; the chemical dissolution does not affect the potential difference between two similar Cu/Cu²⁺ reference electrodes. Designating the left reference electrode as the anode, the electrochemical reactions for these two reference electrodes can be shown in the following equations.

Left side (anode): Cu-2e⁻→Cu²⁺ (2)

Electrolyte: 2Na⁺ (left)→2Na⁺ (molten sulfate salt)→2Na⁺ (right) (3)

Right side (cathode): Cu²⁺+2e⁻→Cu (4)

Assuming that the sodium junction potentials resulting from the diffusion of Na⁺ through the semi-permeable quartz tube and the molten sulfate salt having equal magnitude and opposite signs, the potential difference between two similar quartz sealed Cu/Cu²⁺ reference electrodes is zero theoretically. Ten similar Cu/Cu²⁺ reference electrodes made at separate times were placed in synthetic coal ash with the same immersed depth and the OCPs between any two similar Cu/Cu²⁺ reference electrodes were measured over the temperature range from 500° C. to 900° C. The potential differences between these reference electrodes were less than 5 mV at most time and never greater than 8 mV regardless of the exposure temperature, demonstrating the desirable reproducibility of this reference electrode. The slight potential difference may be attributed to the asymmetric construction of the two reference electrodes or the acceptable experimental error. This reproducibility is comparable to Ag—AgCl and Ag—AgSO₄ reference electrodes reported in the literature.

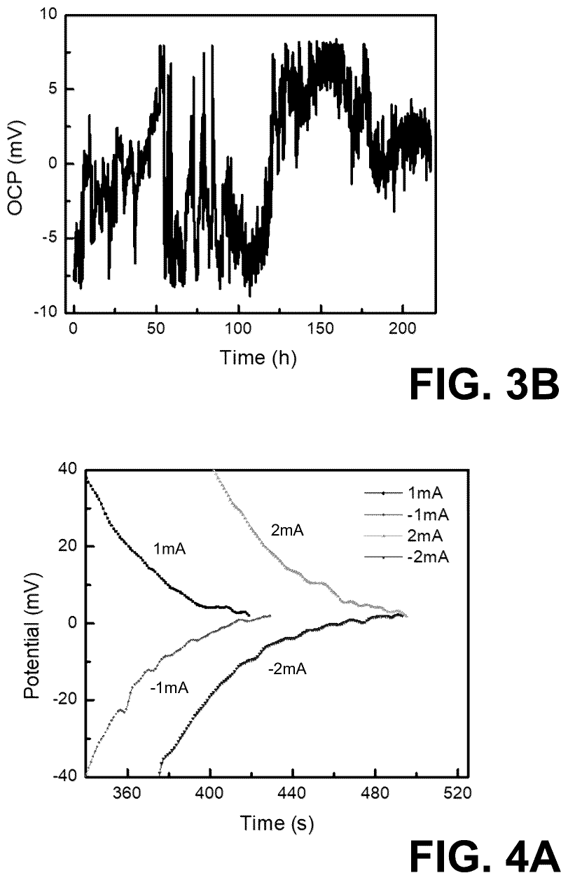

The potential difference between two similar Cu/Cu²⁺ reference electrodes at 600° C. and 800° C. monitored for 200 h is shown in FIG. 3. The potential difference is between-5 mV and 5 mV at 600° C. and from −8 mV and 8 mV at 800° C. over the duration of 200 h, demonstrating good stability of this type of reference electrode over eight days.

Note that these reference electrodes were immersed in the coal ash all the time during the measurement of the potential difference between the two similar reference electrodes at both 600° C. and 800° C. for the 200 hours shown in FIG. 3. The reference electrode has been successfully used in this corrosive environment for a continuous period of 400 h, about 16 days, demonstrating its outstanding durability in molten sulfate salts. Moreover, this reference electrode can be washed by water and stored once it is taken out from the coal ash for the following multiple-time usage without impairing its capability. However, after several usages, the surface of the quartz tube, especially the quartz tube/molten salt/flu gas triple phase boundary was eroded. The erosion site was brittle and prone to breakage. A similar result has been found in a previous report which was attributed to the formation of sodium silicates.

### Polarization of Reference Electrode

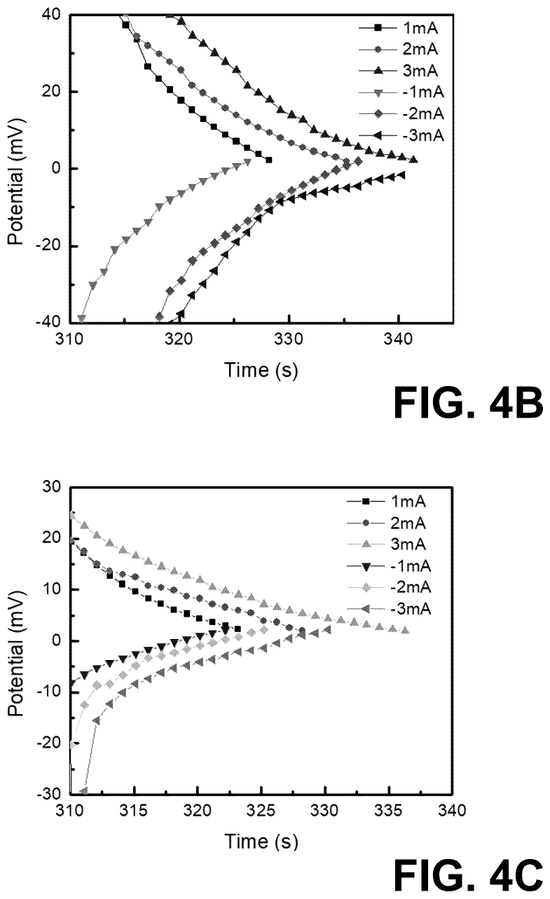

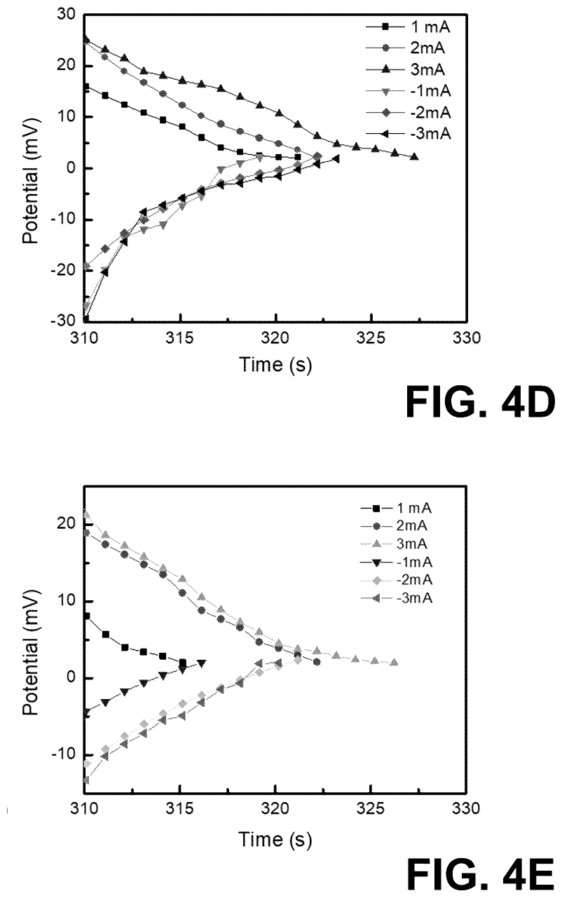

FIGS. 4A-4E show the potential difference between two similar Cu/Cu²⁺ reference electrodes in synthetic coal ash after the flow of a small current (±1 mA and ±2 mA at 500° C. for FIG. 4A, ±1 mA, ±2 mA and ±3 mA at 600° C., 700° C., 800° C. and 900° C. for FIGS. 4B, 4C, 4D and 4E, respectively) for 300 s. The chronopotentiometry measurement with a current of 3 mA at 500° C. could not be performed due to the limited voltage range (−5 V to 5 V) of the electrochemical workstation. The initial value of potential difference (2 mV) was re-established within 120 s and 200 s after the flow of a small current of −/+1 mA and −/+2 mA, respectively at 500° C. (FIG. 4A). No visible difference was observed between cathodic and anodic polarization. The time required to resume the initial value is shortened to less than 40 s with the increase of temperature (FIGS. 4B-4E). These times reflect the recovery of the concentrations of Cu²⁺ at the surface of the Cu wire after polarization. Overall, the Cu/Cu²⁺ reference electrode exhibits similar recovery behavior as Ag/AgCl reference electrodes.

### Reversibility

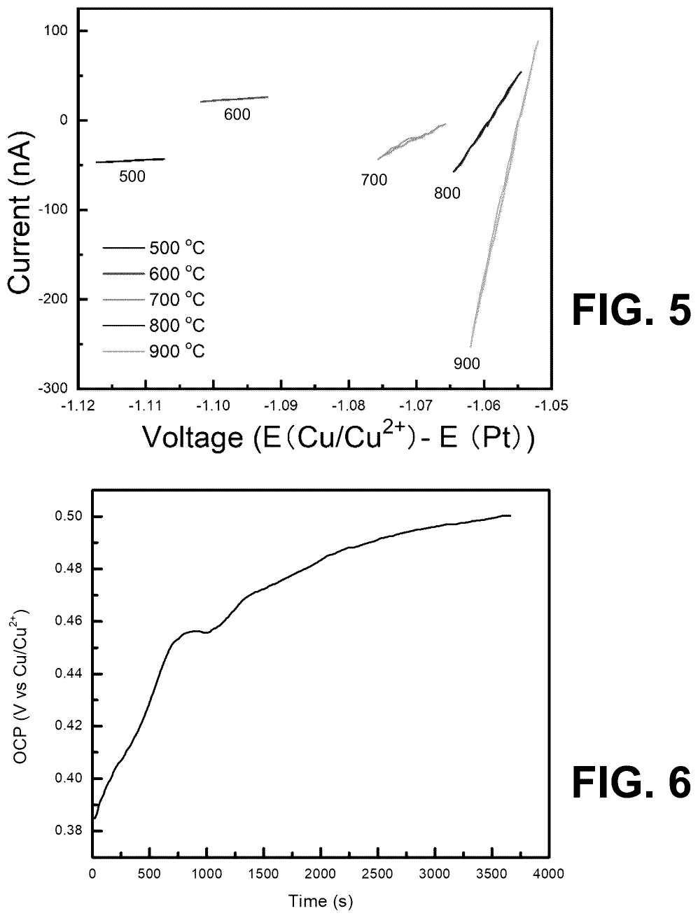

Cyclic voltammetry curves with the Cu/Cu²⁺ electrode as the working electrode and platinum as the counter electrode at different temperatures are shown in FIG. 5. The OCP grows with the increase of temperature which may be attributed to the response of the potential of the Cu/Cu²⁺ reference electrode to temperature. It clearly reveals a linear behavior in the potential range −/+5 mV versus OCP from 500° C. to 900° C. The linear relationship between the current density and potential indicates the good reversibility of the Cu/Cu²⁺ reference electrode in coal ash from 500° C. to 900° C.

### Application of Reference Electrode to Investigate Coal Ash Hot Corrosion Behavior of TP347H Stainless Steel

FIG. 6 depicts the OCP as a function of time in the first hour. The OCP grows from 385 mV to 500 mV versus Cu/Cu²⁺ in the first hour. This may be attributed to the formation of a protective scale composed of oxides of nickel, chromium and their spinels on the surface of the TP347H stainless steel, which is similar to the layer formed on the nickel-based alloy when exposed to the oxidizing atmosphere at elevated temperatures.

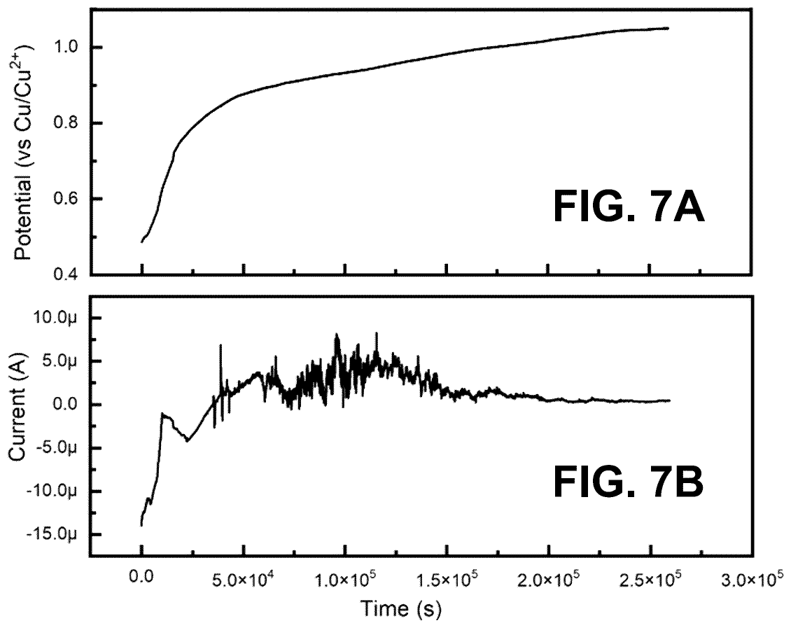

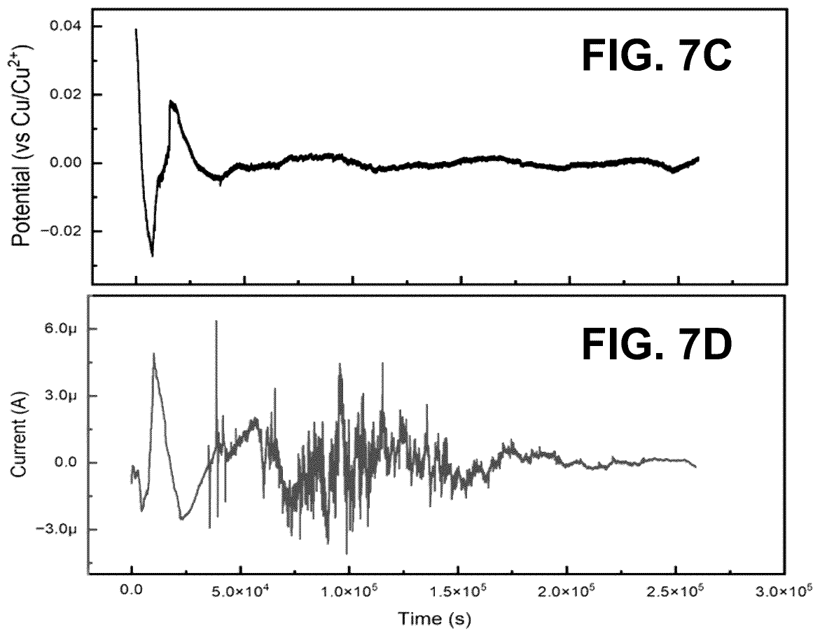

FIGS. 7A-7D depict the (a) potential and (b) current of for two TP347H electrodes held at the same potential as a function of time over a period of 72 hours. The potential and current noise before detrending is depicted in FIGS. 7A and 7B. In the initial corrosion stage, the potential grows from 500 mV to 1.02 V versus Cu/Cu²⁺ and the (absolute) current density decreases gradually from 14 μA to 500 nA. The decrease of potential may be attributed to the growth of oxide scale during the corrosion process. The existence of a negative direct current drift suggests the preferential oxidation of one working electrode in the initial stage which might be ascribed to the accepted asymmetry between two electrodes. After several hours, the negative direct current drift was shifted to be positive, indicating the faster corrosion rate of the other working electrode due to the growth of the oxide scale on the previous working electrode during the initial corrosion process. The trend in the data was calculated using 8th-order polynomials with an R2 of 0.998 for potential and 0.864 for current noise and subtracted to isolate the potential and current noise.

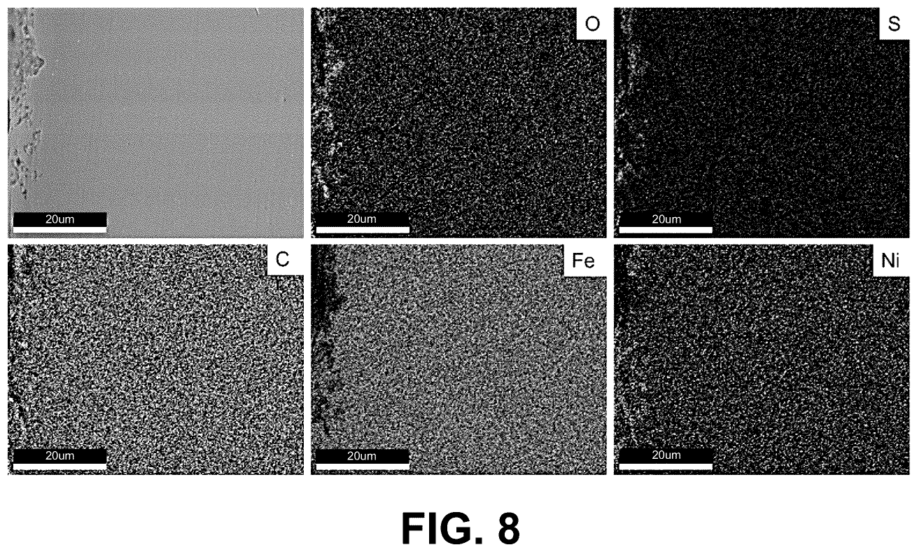

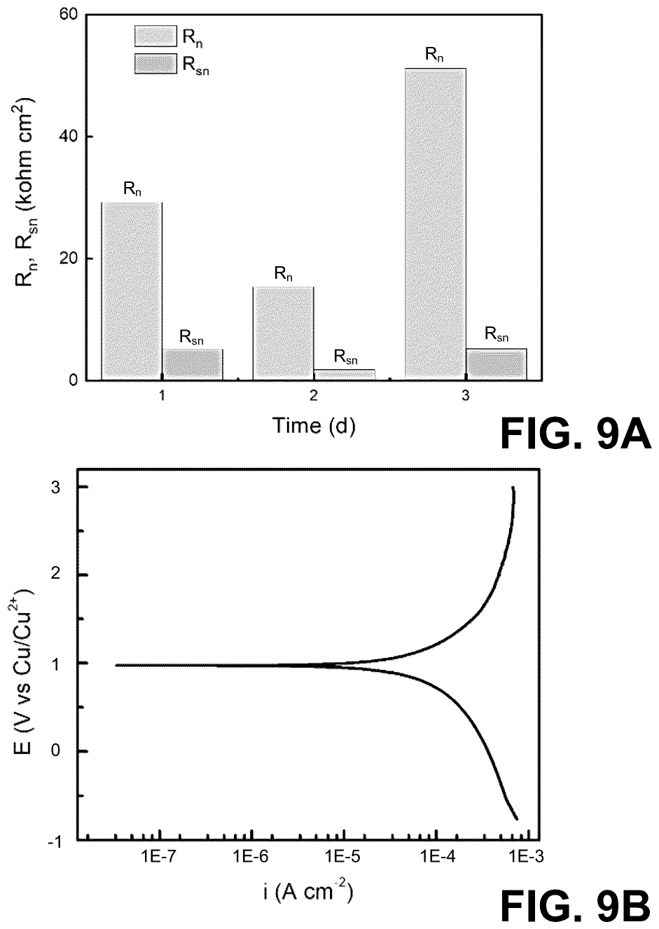

The potential and current noise after detrending is depicted in FIGS. 7C and 7D. The bidirectional transient of current noise indicates the corrosion of both working electrodes in the entire process. Finally, both the potential and current fluctuate randomly in a narrow range, around 1.02 V versus Cu/Cu²⁺ and 500 nA, respectively, which is the characteristic of the sulfidation process, as described in the literature. This experimental result verifies the feasibility of the application of electrochemical noise to monitor the corrosion process of TP347H in coal ash with the aid of this reference electrode. The cross-section morphology of TP347H after hot corrosion for 72 h and the corresponding element distribution shown in FIG. 8 further confirm the formation of oxides and sulfides which is consistent with the corrosion process characterized by the potential and current noise pattern in FIGS. 9A and 9B. FIG. 9A compares the Rₙ and Rₛₙ as a function of time and FIG. 9B illustrates an example of PDP after hot corrosion at 700° C.

After detrending, the potential and current noise was transferred to the frequency domain through Fast Fourier transformation (FFT). Noise resistance, the ratio of the standard deviation of the potential noise to the current noise, in the time domain (Rₙ) and frequency domain (Rₛₙ) has been proved to be an effective indicator of the corrosion rate. The comparison of Rₙ and Rₛₙ value is shown in FIG. 9A. It clearly reveals that Rₙ and Rₛₙ show the same trend. Both Rₙ and Rₛₙ show the highest value in the third day which may be attributed to the formation of oxidation scale during the initial corrosion process, hindering the ingress of oxidization species. The PDP curve ranging from −2 V to 2 V versus OCP after EN test has been successfully obtained with the aid of the Cu/Cu²⁺ reference electrode is shown in FIG. 9B. The OCP is 1.0 V versus Cu/Cu²⁺ which is consistent with the potential noise in FIG. 7B. No signal fluctuation was observed during the measurement.

Compared with other electrochemical measurements such as PDP and EIS, electrochemical noise can be a powerful tool to measure the real-time corrosion rate without any instrumental disturbances. According to the Faraday's law, the corrosion rate (CR, g·cm⁻²) can be calculated through the following:

$$C R = ( M \times i ) / ρ FnS , \qquad ( 5 )$$

wherein i is the current density, in A; F is a Faraday's constant (i.e., 96485 C mol⁻¹); p is the density of TP347H stainless steel (i.e., around 7.84 g cm⁻³); S is the exposed area of the working electrode (1 cm²); M represents the atomic mass of iron (i.e., 56 g mol⁻¹); and n is for the number of electrons transferred per atom of iron (i.e., 3 by supposing all the iron atoms are oxidized to Fe³⁺).

The accumulated corrosion rate calculated through equation (5) is 0.378 mg cm⁻², which is lower than that calculated by weight loss measurement, i.e., 0.459 mg cm⁻². The difference may be attributed to the unavoidable oxidation during the ramp-up and down of the tube furnace. With the aid of this robust reference electrode, electrochemical measurements have been successfully conducted to tentatively investigate the hot corrosion behavior of TP347H stainless steel.

A robust Cu/Cu²⁺ reference electrode with good stability, reproducibility, durability, reversibility and non-polarizability in the temperature range from 500° C. and 900° C. has been developed in this work. The ionic resistance associated with the diffusion of Na⁺ ions through the quartz tube, which is a thermally activated process, decreases with the increase of time. Moreover, the ohmic resistance of this reference electrode is just 6.7 KΩ at 500° C. which is far lower than that of the input impedance in a commercial potentiostat such as, e.g., the Gamry 1010E Interface. With the aid of this reference electrode, electrochemistry tests including open circuit potential (OCP), potentiodynamic polarization (PDP) and electrochemical noise (EN) have been conducted to investigate the coal ash hot corrosion behavior of various alloys in commercial working conditions.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A high temperature reference electrode, comprising:
a quartz tube;
a copper chloride and sodium chloride mixture sealed in the quartz tube; and
an electrode wire disposed in the copper chloride and sodium chloride mixture, the electrode wire comprising an electrode connection extending through a seal of the quartz tube.

2. The high temperature reference electrode of claim 1, wherein the electrode wire is a copper wire disposed in the copper chloride and sodium chloride mixture.

3. The high temperature reference electrode of claim 2, wherein a diameter of the copper wire is in a range from about 0.5 mm to about 2.5 mm.

4. The high temperature reference electrode of claim 3, wherein the diameter of the copper wire is 1 mm.

5. The high temperature reference electrode of claim 2, wherein the electrode connection comprises a tungsten wire welded to an end of the copper wire, the tungsten wire extending through the seal of the quartz tube.

6. The high temperature reference electrode of claim 5, wherein a diameter of the tungsten wire is in a range from about 0.2 mm to about 1 mm.

7. The high temperature reference electrode of claim 6, wherein the diameter of the tungsten wire is 0.4 mm.

8. The high temperature reference electrode of claim 2, wherein the high temperature reference electrode has an ohmic resistance of about 6.7 kΩ at 500° C.

9. The high temperature reference electrode of claim 1, wherein the copper chloride and sodium chloride mixture has a molar ratio of 1:9.

10. The high temperature reference electrode of claim 1, wherein a diameter of the quartz tube is about 10 mm or less.

11. The high temperature reference electrode of claim 10, wherein a thickness of the quartz tube is about 1 mm or less.

12. The high temperature reference electrode of claim 11, wherein the thickness of the quartz tube is about 0.4 mm.

13. The high temperature reference electrode of claim 1, wherein the high temperature reference electrode is a reference electrode in a high temperature electrochemical corrosion sensor.

14. A method for electrochemical testing, comprising:
immersing electrodes of a high temperature electrochemical sensor in a corrosive medium, the high temperature electrochemical sensor comprising a high temperature reference electrode comprising:
a quartz tube;
a copper chloride and sodium chloride mixture sealed in the quartz tube; and
an electrode wire disposed in the copper chloride and sodium chloride mixture,
the electrode wire comprising an electrode connection extending through a seal of the quartz tube; and
obtaining one or more electrochemical measurement via the electrodes immersed in the corrosive medium.

15. The method of claim 14, wherein the electrodes comprise a working electrode comprising an alloy under test.

16. The method of claim 15, wherein the alloy is an austenitic stainless steel.

17. The method of claim 16, wherein the austenitic stainless steel is TP347H stainless steel.

18. The method of claim 15, wherein the electrodes comprise a plurality of working electrodes.

19. The method of claim 14, wherein the corrosive medium comprises coal ash.

20. The method of claim 14, wherein the one or more electrochemical measurement comprises open circuit potential (OCP), potentiodynamic polarization (PDP) or electrochemical noise (EN).
